(19) United States
(12) Patent Application Publication
(10) Pub. No.: US 2007/0067305 A1
(43) Pub. Date: Mar. 22, 2007

(54) Display of search results on mobile device browser with background process

(76) Inventor: Stephen Ives, Cambridgeshire (GB)

Correspondence Address: BARNES & THORNBURG LLP, P.O. BOX 2786, CHICAGO, IL, 60690-2786, US

(21) Appl. No.: 11/289,078

(22) Filed: Nov. 29, 2005

(30) Foreign Application Priority Data
Sep. 21, 2005 (GB) GB0519256.2

(51) Int. Cl. G06F 17/30

(52) U.S. Cl. 707/10

(57) ABSTRACT

A query server of a mobile search engine system for searching content items accessible online, is arranged to send at least a first screenview of search results (63) to a browser of a mobile device (10), and send instructions (69, 74) in a scripting language to the browser for a background process to fetch further search results to the mobile device for presentation later. The further search results can then be viewed as desired without the need for a further round trip delay across the wireless network. The user can be presented with a simpler navigation model. The first screenview can be sent in the form of a page formatting template, and results data. The formatting information can be reused for other results, to reduce formatting overhead in the downloads. The instructions can also be used for showing information while waiting for downloads, or downloading information during entry of search queries.

### RELATED APPLICATIONS

This application relates to earlier U.S. patent applications Ser. No. 11/189,312 filed 26 Jul. 2005, entitled “processing and sending search results over a wireless network to a mobile device” and Ser. No. 11/232,591, filed Sep. 22, 2005, entitled “Systems and methods for managing the display of sponsored links together with search results in a search engine system” claiming priority from UK patent application no. GB0519256.2 of Sep. 21, 2005, the contents of which applications are hereby incorporated by reference in their entirety.

### FIELD OF THE INVENTION

This invention relates to servers for search engine systems, to methods of providing a search service over a wireless network, to methods of using the search service, and to corresponding apparatus or software.

### DESCRIPTION OF THE RELATED ART

The world wide web is a massive store of useful (and useless) information. A good search tool enables general purpose access to this information store. Searching the world wide web is a well solved problem when accessing the web from a desktop personal computer (e.g. Google, Yahoo, et al). Mobile devices that are capable of accessing content on the world wide web are being increasingly numerous. However, pages designed specifically for the small screen sizes of mobile devices are very few. Further, there are only a few very simple search services available to mobile devices.

These search services perform poorly for several reasons:

there are not enough mobile-specific pages available to provide relevant pages for most search queries,

desktop-specific webpages cannot be easily rendered on the limited screen and limited browsers of mobile devices,

direct translation of desktop-specific webpages to the specific markup language supported by most mobile devices (eg XHTML Basic and XHTML Mobile Profile ) is a hard problem, and

network requests suffer high latency regardless of the high bandwidths increasingly available, this means every click by a user on a link takes several seconds for a response regardless of the size of the response.

The information held in the world wide web is therefore very hard to access from a mobile device and particularly from a handset with a small screen.

Search results are typically a page of links to candidate pages. Sometimes these links are accompanied by snippets of text from the candidate pages to assist the user in determining relevancy. The user must then click on these links in turn, possibly skipping seemly irrelevant links, in order to test or check whether the linked page contains the desired information.

This process works fine for a search when using a desktop personal computer connected using a good dial-up or broadband internet connection. It works less well for a mobile device. Search engines for use from mobile devices can be arranged to use conventional browsers on mobile devices, for displaying web pages (for example Google™ mobile), or a custom client application can be installed by the user on their mobile device to run instead of the browser (for example Nokia “mobile search application”) so that search results need not be sent in web page format. The browser based mobile search engines enable use from a wider range of different devices, but operation is slower. The slower network bandwidth and much higher connection latencies of a wireless network means each click to download a page takes at least 2-3 seconds and sometimes several seconds. Google™ Mobile sends less information about each hit in the search results, than its standard search, and uses transcoding of web pages to fit smaller screens typical of handheld devices. This reduces the amount of data sent over the wireless network, but is only partially successful and still suffers high latencies. The search results are still sent as a single page with a list of results including approximately 10 to 20 words as a summary for each result in the list. Testing ten or twenty pages, a typical number required to find target information, can therefore take many minutes. Further, both the list of results and each target page are still larger than the small displays of many handheld mobile devices and so must usually be scrolled (often slowly by the limited capabilities of browsers found on handheld mobile devices) line by line, since the keypads of handheld mobile devices typically have no page up or page down keys. On conventional browsers, once a page has been downloaded to a browser for display, the dialogue with the server is completed. To alter or update the page being displayed usually needs the browser to send a new page request to the server, the server to send the new page as HTML, and the browser to interpret the received HTML to display the page. Hence user experience is very poor and solutions already marketed have very low usage. Efforts have been directed to making the information in each screenview more dense so that fewer page reloads are needed.

This has led to custom application based mobile search engines to address the slowness, and improve the user experience. The custom application enables faster download since little or no page formatting information need be sent compared to the HTML pages needed for browser-based searching. Interaction with the search results is no longer limited to scrolling the current page or downloading a new page. The user has the inconvenience of having to download and install the custom application and keep it updated. The search engine provider has the inconvenience of providing versions of such a custom application for a range of different mobile devices and managing updates for the many versions.

It is also known to provide browsers which attempt to render and display some parts of a web page before the complete page is downloaded. This technique, sometimes referred to as progressive rendering, has varied support. Some browsers although displaying parts of a web page before the complete page has been downloaded do not allow for user interaction until the page has been completely downloaded. Others do not finalise the layout of all items of the page until the page has been fully downloaded. This can often lead to an adjustment of the shape and or position of the parts of the page the user has started to look at. All of these effects contribute to a poor user experience.

### SUMMARY OF THE INVENTION

An object of the invention is to provide improved apparatus or methods. According to a first aspect, the invention provides:

A query server of a mobile search engine system for searching content items accessible online, the query server being arranged to send search results across a wireless network to a mobile device for presentation to a user by a browser on the mobile device in response to a search query, and being arranged to send at least a first screenview of the search results to the browser, and send instructions in a scripting language to the browser for a background process to be run by the browser at least while the first screenview is presented to the user, the query server and the background process being arranged to cooperate to send further information to the mobile device relating to the search results, for presentation to the user under the control of the scripting language instructions.

This can exploit capabilities of some browsers to use scripting languages to run background processes, to provide a new hybrid mobile search system. This can combine some of the benefits typically associated with a custom client application while maintaining some of the benefits of browser-based operation. Compared to the known browser solution described above, the search results are split by the query server so that the user can view the first screenview while the background process is used to download the rest of the information relating to the search results. Thus the critical delay before the user can view the first results can thus be reduced since less information need be contained in the first screenview. The further information relating to the search results can then be viewed as desired without the need for a further round trip delay across the wireless network. Furthermore the use of the instructions to control presentation of the further information means the user can be presented with a simpler navigation model than that possible with the limitations of scrolling and or page-reloading required in the known browser solution. Hence more screenviews can be presented than before and the search results can be more useful and more convenient to use.

An additional feature of some embodiments is: the query server being arranged to send the first screenview in the form of a page formatting template, and results data suitable for presentation using the page formatting template, and the instructions being arranged to reuse the page formatting template to prepare at least some of the further information for presentation.

By using page formatting information as a template for the display of the search results, the screenview can be changed more simply by swapping the data in and out of the page template. The instructions can then be used to control the presentation to the user as desired, such as user navigation to move the screenview to a next result item. This can help enable a simpler navigation model for selecting from multiple screenviews than that possible with the limitations of scrolling and or page-reloading required in the known browser solution.

The template also has the benefit that the further information need not have its own page formatting information unlike the known browser solution described above. This means that the size of the download having the further information can be smaller, resulting in even faster downloads or enabling larger result sets in the same download time. This also helps enable more screenviews than before to be presented so that search results can be richer and the search process made more convenient and efficient for the user.

The page formatting template can be sent in advance of the result data for the first screenview if desired. For example it can be sent together with an initial search request page or together with the result data for the first screenview or sent in parts using both sending opportunities.

An additional feature of some embodiments is: the query server being arranged to send one or more further page formatting templates for different categories of the search results, and further results data of a different category, the instructions being arranged to control the presentation of the further results data by selecting one of the page formatting templates according to the category of the further results data to be presented.

Such further templates and further results data can be sent with the first screenview, or as a response to a background request to avoid increasing the wait for the first screenview, or can be sent in parts using both opportunities, as desired. As discussed above, the further templates at least can be sent in advance of the search. The choice of multiple templates helps enables the page format to be tailored to the content while still reducing the amount of redundant page format information sent across the wireless network.

An additional feature of some embodiments is: the instructions being arranged to alter a page being displayed by the browser by swapping data within the currently used template.

This enables part or all of the data to be updated without the disruption and delay of reloading a complete page.

An additional feature of some embodiments is: the background process being arranged to fetch further information from the server relating to a currently-presented search result without waiting for user input, and canceling the fetch if the user selects a different search result, the further information comprising any one or more of: further search results similar to the currently displayed search result, more details of the currently displayed search result, a longer summary or extract of the currently displayed search result, and other information.

This look ahead facility also helps reduce the wait time for such further information and hence can make searching faster and more convenient.

An additional feature of some embodiments is: the search results having content summaries of original content items and the query server being arranged to cooperate with a content summariser for generating content summaries, a format of the content summaries being arranged according to a category of the corresponding original content.

This helps enable a consistent format which helps reduce a number of different page formatting templates and so helps reduce an amount of overhead.

An additional feature of some embodiments is: the first screenview of the search results having an overview of groups of the search results.

This can help a user find a desired result more conveniently, and again helps limit the wait for the first screenview.

An additional feature of some embodiments is: the query server being arranged to carry out a preliminary step of sending a search query entry window for display by the browser, the instructions being arranged to send to the query server characters of a search query entered by a user before the query is completed, the query server being arranged to match the characters to predetermined subject categories derived from previous search results, and send the matching subject categories to the browser for presentation to the user ahead of the presentation of search results from the completed query.

This can help enable a user to use the wait time to review the categories, or can help enable a user to complete or refine the search query more effectively.

An additional feature of some embodiments is: the query server being arranged to send interval information for presentation to the user, controlled by the instructions during intervals while awaiting a response from the server, the instructions being arranged cause the interval information to be stored until a suitable interval is detected then cause the interval information to be presented to the user.

An additional feature of some embodiments is: the interval information having any one or more of: advertising information, advertising information related to the search being undertaken, news items, information about the search system, estimated wait time remaining, percentage or fractional progress completed, and other information about the search being undertaken.

Another aspect of the invention provides:

A method of providing a search service for searching content items accessible online, to a user of a mobile device having a browser and being coupled by a wireless network, the method having the steps of receiving a search query from the user, getting search results, sending at least a first screenview of the search results to the browser, sending instructions in a scripting language to the browser for a background process to be run by the browser at least while the first screenview is presented to the user, and cooperating with the background process to send further information to the mobile device relating to the search results, for presentation to the user of the mobile device under the control of the scripting language instructions.

Another aspect provides:

A method of using a search service for searching content items accessible online using a mobile device having a browser and being coupled by a wireless network, the method having the steps of sending a search query to the search service, receiving from the search service at least a first screenview of search results for presentation by the browser, receiving from the search service instructions in a scripting language for a background process to be run by the browser at least while the first screenview is presented to the user, receiving from the search service further information relating to the search results, fetched by the background process run by the browser, and causing the further information to be presented by the mobile device under control of the scripting language instructions.

Another aspect of the invention provides:

A query server of a search engine system for searching content items accessible online, the query server being arranged to send at least a first screenview of search results and send instructions in a scripting language across a wireless network to a browser on a mobile device in response to a search query, the first screenview being sent in the form of a page formatting template, and results data suitable for presentation using the page formatting template, and the instructions being arranged to reuse the page formatting template to prepare further screenviews for presentation by the browser.

This aspect reflects that the advantages of the template reuse are not necessarily dependent on the use of the background process to fetch further information for presentation.

Another aspect of the invention provides:

A query server of a search engine system for searching content items accessible online, the query server being arranged to send at least a first screenview of search results and send instructions in a scripting language across a wireless network to a browser on a mobile device in response to a search query, the query server also being arranged to carry out a preliminary step of sending a search query entry window for display by the browser, the instructions being arranged to send to the query server characters of a search query entered by a user before the query is completed, the query server being arranged to match the characters to predetermined subject categories derived from previous search results, and send the matching subject categories to the browser for presentation to the user ahead of the presentation of search results from the completed query.

Again this aspect reflects that the advantages of the presentation of matching subject categories before the query entry is completed are not necessarily dependent on the use of the background process to fetch further information while results are presented.

An additional feature of some embodiments is: the instructions being arranged to present the matching subject categories with the search query entry window.

This can enable the user to modify the search query in view of the matching subject categories, and so help a user to focus a search more quickly and make better use of wait time.

Another aspect of the invention provides:

A query server of a search engine system for searching content items accessible online by users of mobile devices coupled across a wireless network, arranged to send instructions to a browser on the mobile device for a background process to be run by the browser, and arranged to send interval information for presentation to the user controlled by the instructions during intervals while awaiting a response from the query server, the instructions being arranged to cause the interval information to be stored until a suitable interval is detected, then cause the interval information to be presented to the user.

Again this aspect reflects that the advantages of the presentation of interval information are not necessarily dependent on the use of the background process to fetch further information while results are presented.

An additional feature of some embodiments is: the interval information having any one or more of: advertising information, advertising information related to the search being undertaken, news items, information about the search system, estimated wait time remaining, and other information about the search being undertaken,

Additional features and aspects of the invention will be described below.

Any of the additional features can be combined together and combined with any of the aspects. Other advantages will be apparent to those skilled in the art, especially over other prior art. Numerous variations and modifications can be made without departing from the claims of the present invention. Therefore, it should be clearly understood that the form of the present invention is illustrative only and is not intended to limit the scope of the present invention.

### BRIEF DESCRIPTION OF THE DRAWINGS

How the present invention may be put into effect will now be described by way of example with reference to the appended drawings, in which:

FIG. 1 shows a schematic view of an embodiment of a search engine system and its environment,

FIG. 2 shows a known sequence of events during a search,

FIG. 3 shows a sequence of events according to an embodiment involving a background fetch,

FIG. 4 shows a sequence of events according to an embodiment involving a background process using a template to reduce formatting overhead,

FIG. 5 shows a schematic view of processes and entities on the mobile device according to an embodiment involving a formatting template as a background process,

FIG. 6 shows a sequence of events according to an embodiment involving a background lookahead fetch,

FIG. 7 shows a sequence of events according to an embodiment involving multiple background processes

FIGS. 8 and 9 show alternative embodiments of search engine systems,

FIG. 10 shows a sequence of events according to an embodiment involving augmenting a query entry window with choices of matching subject categories before a search query is completed,

FIG. 11 shows a sequence of events according to an embodiment involving a presentation of information during wait intervals,

FIG. 12 shows a package of content summaries as search results for use in embodiments,

FIG. 13 shows an arrangement for generating content summaries for a query server,

FIGS. 14 and 15 show overview screenviews, and

FIG. 16 shows content summary screenviews.

### DESCRIPTION OF THE PREFERRED EMBODIMENTS

Definitions

A content item can include a web page, an extract of text, a news item, an image, a sound or video clip, an interactive item such as a game, or many other types of content for example.

Items which are “accessible online” is defined to encompass at least items in pages on websites of the world wide web, items in the deep web (e.g. databases of items accessible by queries through a web page), items available internal company intranets, or any online database including online vendors and marketplaces.

A “keyword” can encompass a text word or phrase, or any pattern including a sound or image signature.

Hyperlinks are intended to encompass hypertext, buttons, softkeys or menus or navigation bars or any displayed indication or audible prompt which can be selected by a user to present different content.

The term browser is intended to encompass software for retrieving and presenting items that are accessible online such as web pages in a mark up language, and encompasses microbrowser applications.

The term “subject category” is intended to encompass categories of subject matter of content items, for example where a query term has a number of meanings or contexts or will produce a number of clusters of related results.

The term “comprising” is used as an open ended term, not to exclude further items as well as those listed.

“search results” is intended to encompass any of: a list of web site names or titles, a list of web site URLs, a number of summaries of content items of web sites, in text or other media formats, audio, image, video and other media content items, or combinations of these.

“presenting” is intended to encompass displaying text or images, playing of audio or video media, and playing of an audio representation of text for example.

“scripting language” is intended to encompass high-level programming languages such as JavaScript, ASP (Active Server Pages, which use ActiveX scripting), and Perl, that are interpreted by another program at runtime rather than compiled. Instructions in such languages can be embedded within a mark up language document such as an HTML document, to process data to be viewed in a browser window for example.

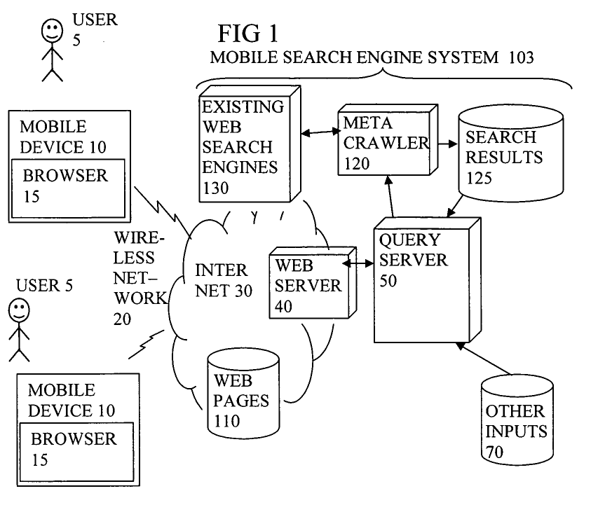

FIG. 1, Overall Topology

The overall topology of a first embodiment of the invention is illustrated in FIG. 1.

FIG. 1 shows the Internet 30, and two mobile devices 10 of end users 5, coupled to the internet over a wireless network 20, and having browsers 15. In principle, the mobile devices could be coupled to other applications, for example in car computers with voice interfaces to enable users to search and obtain information from the web while driving.

In FIG. 1, cylinder symbols represent stored information such as databases which may be implemented on a hard disc or in semiconductor memory for example, and may be distributed or local, and may be managed with appropriate back up and access security, following established practice. Cuboid shapes in this figure represent processes which may run as application software on their own server or be distributed or may share a server for example.

The search query is typically one or more keywords sent by the browser to the known internet address (URL) of the query server. It is sent as a request and is sent via a conventional protocol stack in the mobile device to enable communication over the wireless communications network. The protocol stack typically comprises the standard WAP or TCP/IP protocols which allow the mobile device to communicate with internet hosts and the transport and physical layer protocols, for example GPRS or the third generation UMTS protocols, that enable the mobile terminal to access and communicate data over the wireless communications network. The mobile terminal establishes a communications link to a WAP gateway or network access server (NAS) that interfaces the wireless network to the internet and routes the browser's request across the internet.

The query server 50 is coupled to the internet via a web server 40. The query server passes the query to one (or more) search engines 130 via a meta crawler 120. This operates in the normal way to build a search results list 125 in response to the search query. Optionally the query server can operate as a front end only, in which case it could select a search engine of another organization at a remote location, which would use a content summariser and store of content summaries of that other organization or location. The functions remain similar wherever they are carried out or by which ever organization. Optionally the query server can be located at the interface between the wireless network and the internet, and be part of a service provided by the wireless network operator. The relevant content summaries are returned to the query server and formed into a package suitable for browsing on the mobile device of the user. Other inputs 70 are fed from a store to the query server for use in forming the package. Such other inputs can include advertising or news material for presenting to the user, or characteristics of the mobile device or its browser, characteristics of the wireless network channel, user location, user preferences and so on, for use in determining how much to send, and in what format and so on. These parts described form a mobile search engine system 103. The query server sends the package via the web server, the internet and the wireless network to the mobile user.

The system can be formed of many servers and databases distributed across a network, or in principle they can be consolidated at a single location or machine. The term search engine can refer to the front end, which is the query server in this case, and some, all or none of the back end parts used by the query server.

The users 5 connected to the Internet via mobile devices 10 can make searches via the query server. The users making searches (‘mobile users’) on mobile devices are connected to a wireless network 20 managed by a network operator, which is in turn connected to the Internet via a WAP gateway, IP router or other similar device (using known principles and so not explained here in more detail). Many variations are envisaged, for example the content items can be elsewhere than the world wide web, and so on.

Description of Mobile Devices

The user can access the search engine from any kind of mobile computing device, including laptop and hand held computers. Mobile users can use mobile devices such as phone-like handsets communicating over a wireless network, or any kind of wirelessly-connected mobile devices including PDAs, notepads, point-of-sale terminals, laptops etc. Each device typically comprises one or more CPUs, memory, I/O devices such as keypad, keyboard, microphone, touchscreen, a display and a wireless network radio interface.

These devices can typically run web browsers or microbrowser applications e.g. Openwave™, Access™, Opera™ Mozilla™ browsers, which can access web pages across the Internet. These may be normal HTML web pages, or they may be pages formatted specifically for mobile devices using various subsets and variants of HTML, including cHTML, DHTML, XHTML, XHTML Basic and XHTML Mobile Profile. The browsers allow the users to click on hyperlinks within web pages which contain URLs (uniform resource locators) which direct the browser to retrieve a new web page.

Description of Servers

Although illustrated as a single server, the same functions can be arranged or divided in different ways to run on different numbers of servers or as different numbers of processes, or be run by different organisations.
a) The query server handles search queries from desktop PCs and mobile devices, passing them onto the other servers, and formats response data into web pages customised to different types of devices, as appropriate.

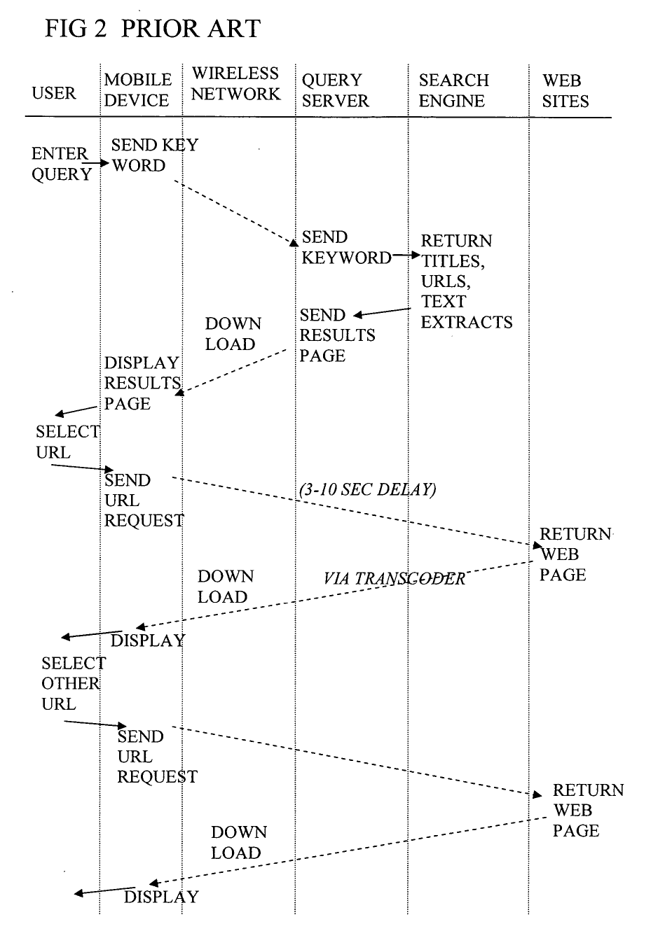

Optionally the query server can operate behind a front end to a search engine of another organization at a remote location. Optionally the query server can carry out ranking of search results or this can be carried out by a separate ranking server. The query server is typically connected to a database that stores detailed device profile information on mobile devices and desktop devices, including information on the device screen size, device capabilities and in particular the capabilities of the browser or microbrowser running on that device. The database may also store individual user profile information, so that the service can be personalised to individual user needs. This may or may not include usage history information.
b) Web server programs can be separate or integral to the query server and other servers. These can be implemented to run Apache™ or some similar program, handling multiple simultaneous HTTP and FTP communication protocol sessions with users connecting over the Internet.
   FIG. 2, Conventional Sequence

FIG. 2 shows a sequence chart of conventional actions of various entities with time flowing downwards, for comparison with later figures which show corresponding charts for embodiments of the invention. In FIG. 2, a user enters a query into the mobile device (in principle the query could be entered elsewhere such as a desktop computer, for sending results to the mobile device). The mobile device sets up a path for the query and response operation using e.g. WAP or TCP/IP protocols with the query server. This typically involves an exchange of many low level messages, adding to the delay or latency of the wireless network. This enables the keyword to be sent to the query server, which communicates with a search engine to return results in the form of titles, URLs and text extracts having the keywords. A page of these results in the form of an annotated list is sent to the mobile device. As shown by the dotted line arrows, this download across the wireless network causes significant additional delay. The results page is then displayed by the mobile device. A user can then select one of the results and click on it to cause the browser on the mobile device to send a URL request. This will be routed across the wireless network to a transcoding engine which will access the original web page corresponding to that URL, and reformat it into a form suitable for display on the screen of that mobile device. If this document is not quite what the user wants, the request and download process is repeated.

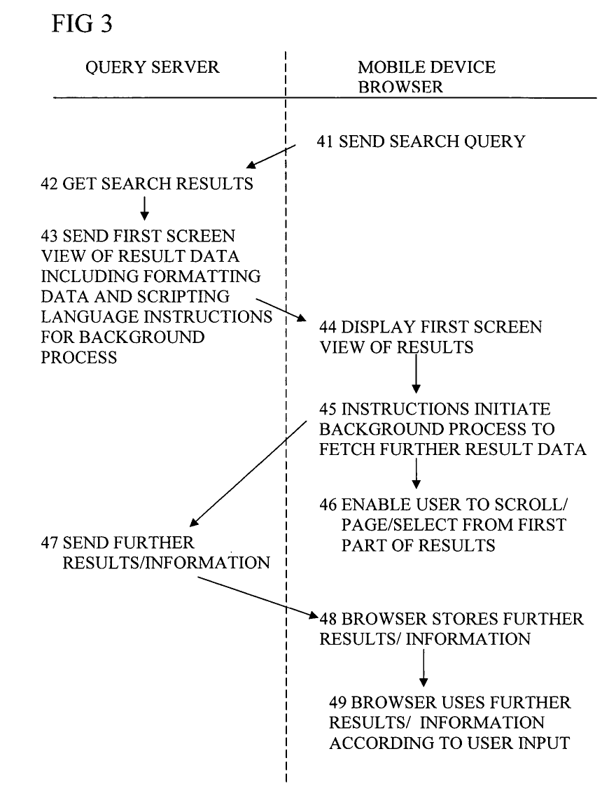

FIG. 3, Background Process for Fetching More Results

The embodiments are concerned with improving the slow scroll+load+browse of one result at a time as described above. Some embodiments are based on a recognition that if every search result is sent as a summary with XHTML or HTML formatting there is a large amount of repeated formatting information. In a typical example, if a summary takes up 1 k of data and 10 summaries are sent as a page to the user's browser, there may be 10-20 k of formatting overhead in the results page. This can cause slow rendering of whole page, since many handheld mobile devices have limited processing speed. By using background fetches, the first page can be made smaller to reduce the long load time of a results page. This can avoid or reduce the need to cut down the number of results downloaded, or avoid the need to reduce the size of the summaries in the results. This is compatible with having search results of different types in one search result page, thereby implying a need for per-item XHTML OR HTML formatting.

Shown in FIG. 3 is a sequence of events again with time flowing down the figure. In the left hand column are actions at the query server side, and the right hand column shows actions at the browser on the mobile device, including background processes. At step 41, the user sends a search query, typically by entering terms into a search page sent by the query server. At step 42, the query server gets search results based on the query terms. Optionally this can be achieved by the search engine system shown in FIG. 1, or by other systems. At step 43, it downloads to the mobile device the first (or first few) result item(s) in the form of one or more screenviews which may be adapted to a known screensize or to a typical screensize. Also downloaded is corresponding (XHTML OR HTML for example) formatting data. Optionally the query server can alter the formatting to suit the browser. The query server also downloads instructions in a scripting language for the browser to run a background process. Optionally all or part of this code can be downloaded earlier with the search page, or any other preliminary download occurrence. The browser displays the results page at step 44 and at step 45 runs the background process to fetch further results or information, while the user is able to scroll the first results, or select from them at step 46, using hypertext links to trigger a further download.

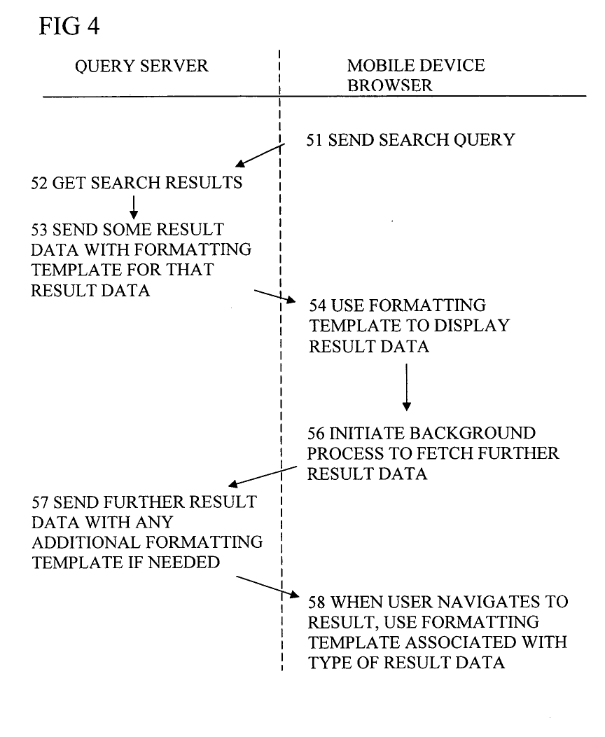

The background process can be regarded as a background thread of execution (also called an asynchronous request, and can be implemented for example. using Javascript's XmlHttpRequest object). It can be used to fetch and store the rest of the result items (and, if needed by the browser, their formatting data). The user can navigate the results that have already arrived in the handset (for example by a navigation key, key pad keys, a thumb wheel, screen focus selection, touch screen, and so on) to scroll or page the content. At step 47, the query server cooperates with the background process to download the further results as requested, without causing them to be displayed by the browser. They are stored in the mobile device by the background process at step 48, for use at step 49 according to user input. For example the further results downloaded by the background process can be viewed as a new page or by keeping the existing page with its existing page format and swapping out the old data and replacing it with new data, as described with reference to FIG. 4.

The background processes can use JavaScript and the XMLHttpRequest object. This object, first implemented by Microsoft as an ActiveX object but now also available as a native object within browsers such as Mozilla and Apple's Safari browser, enables JavaScript to make HTTP requests to a remote server without the need to reload the page. In essence, HTTP requests can be made and responses received, completely in the background and without the user experiencing the visual interruption of a page reload. support for XmlHttpRequest and for DHTML is provided in newer mobile phones (e.g. Opera on Nokia Series 60).

FIG. 4 Embodiment using Template

FIG. 4 shows another sequence according to an embodiment. This is also based on a recognition that if every search result is sent as a summary with XHTML or HTML formatting there is a large amount of repeated formatting information. In this embodiment, instructions in a scripting language are sent and used to enable formatting data for a first result to be reused as a template for page formatting of further results, so that less formatting data need be sent with the further results. Hence a download time for the further results can be reduced. As shown in FIG. 4, at step 51 a search query is sent, at step 52 the query server gets search results, and at step 53 some of the results are downloaded as a page to the browser, together with a formatting template for that result data. At step 54 the formatting template is used by the browser to display or otherwise present the result data. At step 56 the downloaded instructions cause a background process to run to fetch further result data as described above with regard to FIG. 3. At step 57, the query server responds by sending the further result data together with any additional formatting template if needed. At step 58, when the user navigates to a given result, the instructions cause the existing template to be reused to present the result data, or cause another formatting template associated with the desired result data to be used. The reuse of the formatting template enables the browser to avoid reloading a complete page and so can save time or save the user from tedious scrolling In other words, the formatting data is downloaded as a template with the first result item data, using the template to display it. A background thread is run by the browser to fetch the remaining data of data items only (without page formatting content). A user can navigate the results by scrolling or paging which the background thread interprets and arranges for the data of the previous item to be swapped out for the data of the next item within the formatting template.

An example can be implemented using Javascript instructions and results data in the form of JSON (Javascript data over-the-air) which is read directly by the Javascript to form Javascript data objects. When the Javascript wants to present the data, it accesses the data objects and inserts them into a piece of HTML and inserts that HTML piece into the current page to alter the display without the time consuming process of reloading the page. The user can navigate to a next result by a keypress or pointer action, which will be intercepted by the Javascript instructions. They will determine whether to change the current result item (screenview).

if changing screenview, the new result data is read.

the type field in the new result data determines which template (stored fragment of HTML) will be swapped into the main area of the page.

that template is populated with the result data from the new result item (by inserting the strings for ‘title’, ‘source’, ‘body’ etc).

the populated template is inserted into the current page.

This reuse helps enable a much lower percentage of formatting overhead to be achieved compared to sending HTML pages, where in a typical case 50% of the data sent is formatting overhead.

This sequence can be combined with the sequence of FIG. 3, so that the background process fetches further results or information without awaiting user input. The use of scripting language instructions to control the user navigation of results means the user can see a number of options such as get more of the search results, get the original content of a selected result, get more results like a selected result, edit search query, get a longer summary or extract of a selected result.

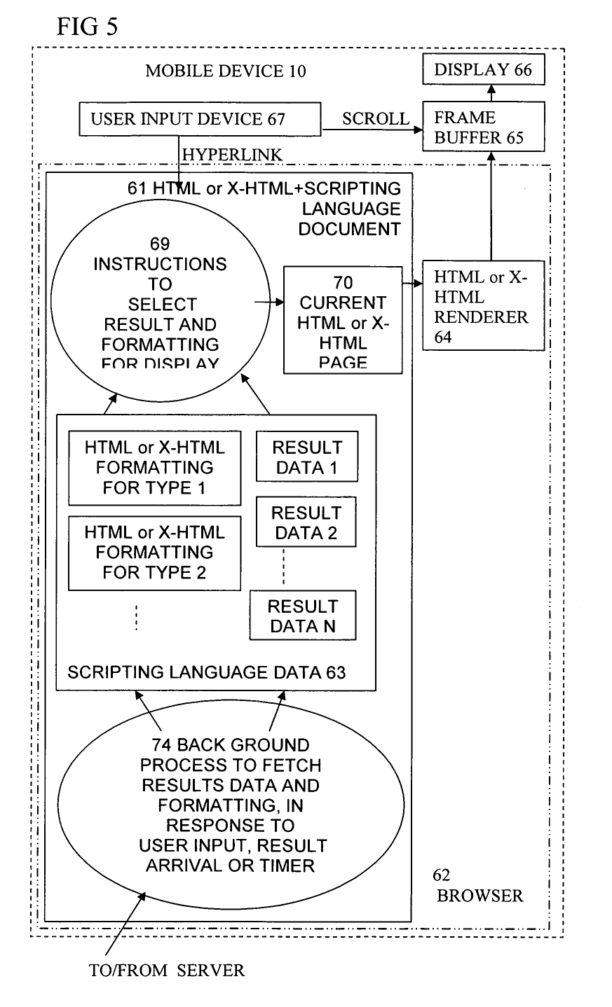

FIG. 5 Schematic View of a Mobile Device

FIG. 5 shows a schematic view of processes and entities on the mobile device according to an embodiment involving a formatting template. The mobile device 10 has a user input device 67, a browser 62 which processes an HTML or X-HTML+scripting language (e.g. Javascript) document 61. This outputs an HTML or X-HTML page to a HTML or X-HTML renderer 64 of the browser, which in turn outputs display pixels to a frame buffer 65 which drives a display 66 of the mobile device. The user input device can encompass known devices such as audio input, hard or soft buttons or pointers for example, to scroll by controlling an output of the frame buffer or by selecting a displayed hyperlink. Multiple screenviews in the form of result data 1, 2 and N are shown already loaded into on board storage, together with formatting templates, in this case HTML or X-HTML formatting for type 1 and HTML or X-HTML formatting for type 2. The document 61 incorporates instructions 69 in a scripting language such as Javascript, to select a result according to user input, for formatting and presentation, to create a current HTML or X-HTML page 70 for output to the renderer. The document also has scripting language instructions 74 for a background process to fetch results data and further formatting templates, in response to user input, result arrival events, or timers for example. In response to prompts such as hyperlinks in the screenview, the user makes a selection which is detected by the user input hardware and fed to background processes to trigger action corresponding to the selection.

This is arranged to enable multiple templates for results of differing categories. For example news item results might have one page format and images or other webtext results might have a different format. In other words, a first result item is downloaded with the particular template that is relevant to that first result item's category. A background thread is initiated as before to fetch remaining result data, without formatting. A user navigates the results that have arrived, and causes the background thread to alter the display by arranging for the data of the previous item to be swapped out for the data of the next item. Where the type of the next item is different to the previous, the template is also swapped for one to suit the type of the next item—that template coming from the initial download or a further download.

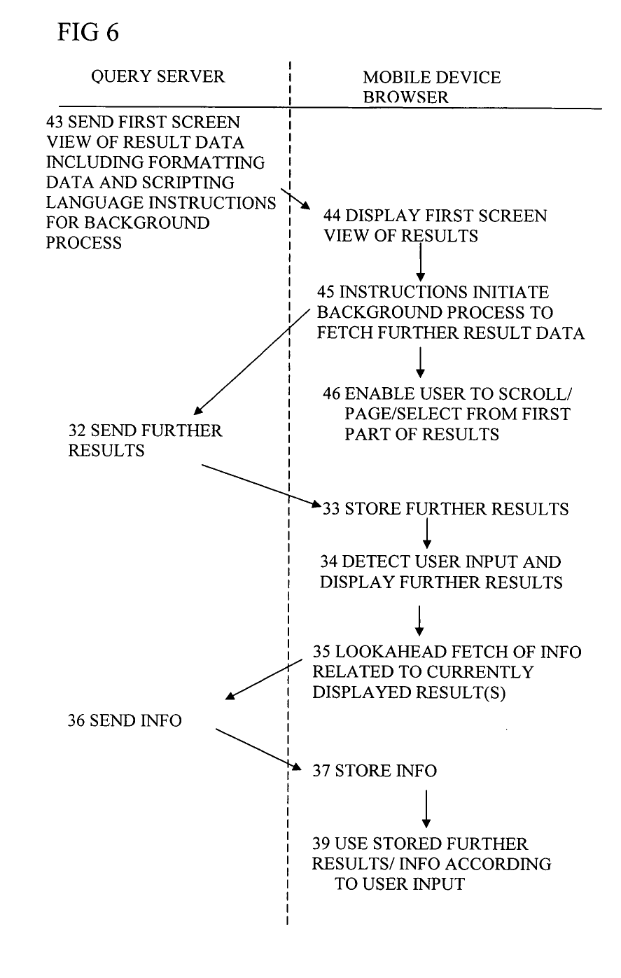

FIG. 6 Embodiment with Lookahead Fetch

While browsing the result set by any of the above methods (or conventional methods), following on search results could be loaded by a background thread in preparation for if the user wants to see more results like, or perform another search about, or just more information on, the currently-in-view (focused) search result. In the example shown in FIG. 6, at step 43, the query server sends a results page with at least a first screenview of results data and formatting data, and scripting language instructions for a background fetch process. As before, at step 44, the browser displays the first part of the results. At step 45, the instructions initiate the background process to fetch further results. A user is able to scroll/page/select from the displayed results at step 46. At step 32 the query server sends further results which are stored at step 33. At step 34 these are displayed in response to user input such as scrolling. At step 35 a lookahead fetch is carried out in anticipation of user selection, to fetch information related to a currently displayed result or results. This information, such as a more detailed summary of the content, is downloaded at step 36 and stored at step 37, ready for use at step 39 according to user input.

The stimulus to initiate this look-ahead result loading could be immediately that the user has arrived at the current result item or some delay after that point. Moving on to the next item could cancel the current request before beginning the next item's further info/follow-on background search. Whether to cancel these or not can be made to depend on the handset resource limits (e.g. RAM, number of network connection limits).

This look-ahead technique can be used for any of:

performing the ‘more like this’ search,

fetching more about the current search result,

fetching more search results of the same category of subject matter.

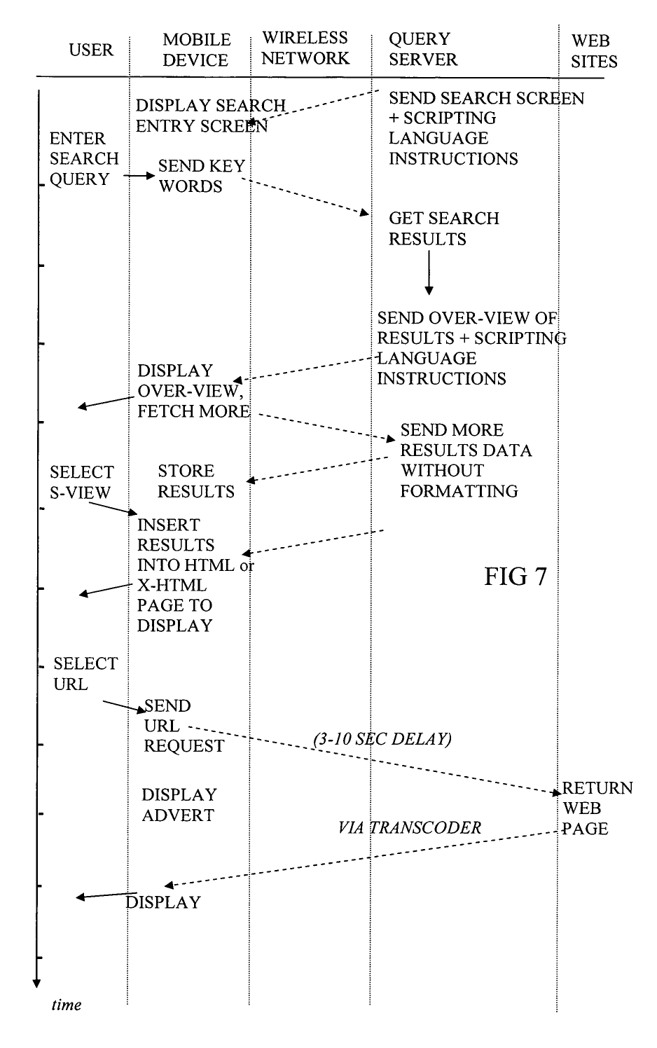

FIG. 7 Sequence of Events According to an Embodiment Involving Multiple Background Processes

FIG. 7 shows a sequence chart for an embodiment using multiple background processes.

The query server sends a search entry screen and optionally sends scripting language instructions for background processes. This screen is displayed and the user enters search query terms such as keywords. The browser sends this query to the server which involves setting up a path over the wireless network to the query server. In this case the search engine searches an indexed database and returns relevant results to the query server. The query server prepares the results which can optionally include an overview and/or a package of summaries (examples are described below). A first part is downloaded to the mobile device across the wireless network. Instructions for background processes is also included in the download. The mobile device displays the first screenview of the package which is an overview screenview in this case. The background process may cause a background fetch of more of the search results while the first part is being displayed. A user can select another screenview to cause one or more of the screenviews of further search results or content sumaries to be presented.

As described above, this can involve reusing the same formatting template so that the further results can be sent without formatting overhead. This browsing of stored screenviews of search results can be repeated until the user finds a desired or optimum result which suits, then they can select a URL to request the whole content item, usually via a transcoding engine if the mobile device has a small screen size. Alternatively the user can request more content summaries be sent, or can retry the search with different keywords for example. If the further results are downloaded using XML formatting, a background process in the form of a formatting template can be used to convert them to fully formatted HTML or X-HTML pages. Another background process can be used to display advertising material in the wait time interval while the content web page is downloaded.

The server can monitor how the browser responds when sent a download including scripting language instructions. If there is no response, the server can deduce that the browser does not support such instructions or can try resending using a different scripting language for example. In some cases the server will see a UserAgent field in the HTTP request header received from the browser. This identifies the browser and often the handset model number. From this it is sometimes possible to look up the device's browser capabilities.

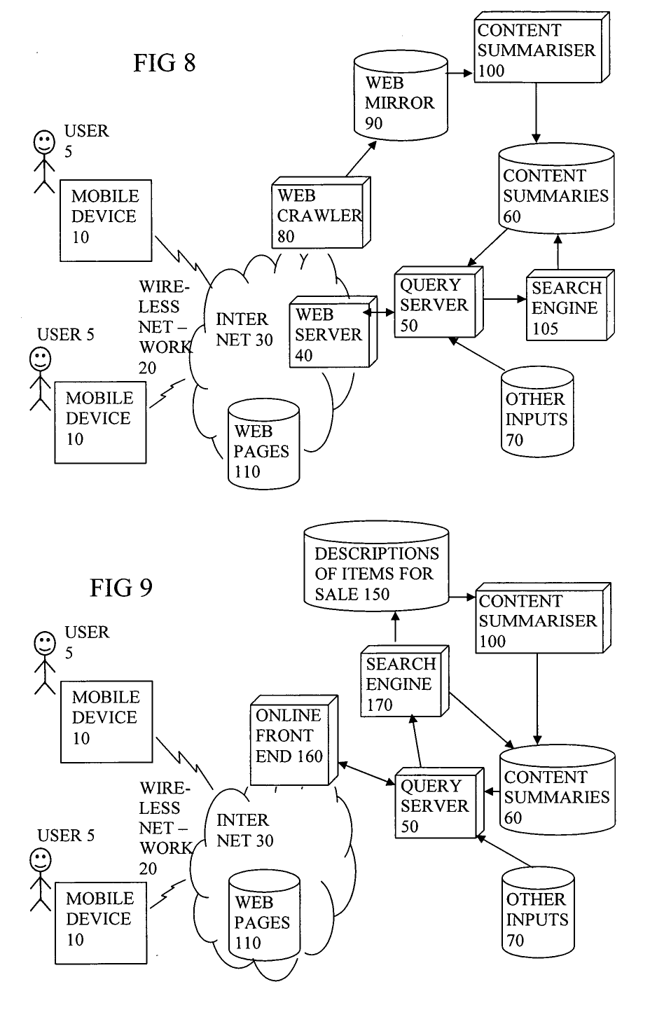

FIGS. 8 and 9, Alternative Embodiments of Search Engine Systems

FIGS. 8 and 9 show alternative arrangements for search engine systems using the query server and having some similar features to FIG. 1, and corresponding reference numerals have been used as appropriate. In FIG. 8, a content summariser 100 is provided to build up a database 60 of content summaries. A web crawler 80 searches the world wide web via the internet 30 to assemble a copy of web pages in a web mirror 90, which is then accessed by the content summariser 100 Search queries are received by the query server and passed to a search engine 105 for searching for relevant content summaries in the content summary database 60, managed by the search engine. The search engine can have an index server that builds a searchable index of all the web pages in the web mirror, stored in the index, this index containing relevancy ranking information to allow users to be sent relevancy-ranked lists of search results. This is usually indexed by ID of the content and by keywords contained in the content. The content summariser builds its summaries by following the links to web pages from URLs in the results list, loading these web pages, and processing them to extract the appropriate summary information.

The content summariser can be arranged to read multimedia files collected on the web mirror, sort them by category, and for each category derive a summary.

In the case where the query server is passing the query to multiple search engines, it is acting as an enhanced metacrawler which is carrying out an additional content summarization step when compared with existing metacrawlers.

FIG. 9 shows another alternative embodiment having some similar features to FIG. 1, and corresponding reference numerals have been used as appropriate. In this case, the search is of items for sale via an online store or marketplace, (or even of items in a conventional store or warehouse to provide more information about items on the shelves, to mobile devices of shoppers or staff in the store or warehouse). Content summaries are created on demand or off line, or some combination. An online front end 160 to the store or marketplace, (such as Ebay™ or amazon™) receives a search query for an item. This could be direct from the user, or from an intermediary service which searches many on line stores or marketplaces for example. The front end passes the search query to the query server 50. This could be arranged so that all search queries are handled by the same query server, or the front end might distinguish those from mobile devices over a wireless network and just pass those to the query server. This manages the search by passing the query to a search engine 170 arranged to search either or both of a database 60 of content summaries, and a database 150 of information on items for sale. In the latter case, results are passed to a content summariser 100 and content summaries are stored in database 60 as before. Relevant content summaries, are fed from the store to the query server for packaging and sending to the mobile device.

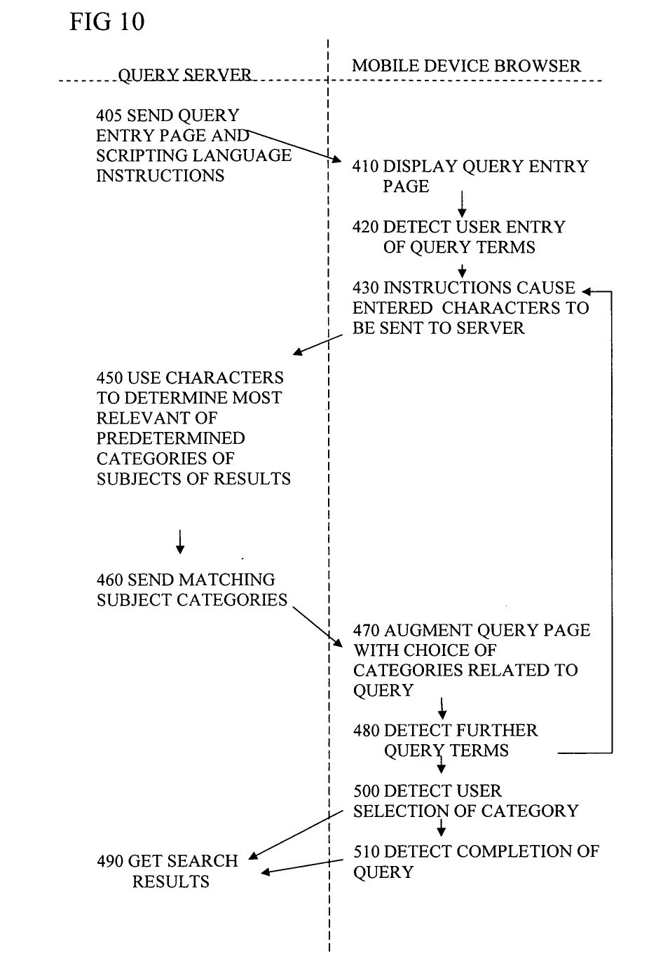

FIG. 10 Embodiment Involving Augmenting a Query Entry Window with Choices of Matching Subject Categories

FIG. 10 shows a sequence of events for an embodiment which uses a background process to enable pre-emptive augmenting of the search query entry. As the user types each character or word of the initial search input box, each character is transmitted by a background thread/process to the server. The server uses this advance notice to alter a different part of the user's screen with a choice of categories that are relevant to the term typed so far. A user may well get used to the delay that is likely with a mobile wireless device and type a term without submitting it, waiting for the refinement options to appear before initiating a more expensive (in terms of time) request for a results payload—having narrowed down the result ‘breadth’ in advance.

In the example shown in FIG. 10, at step 405 a query server sends a query entry window typically in the form of a page and scripting language instructions for a background process to the browser. The page is displayed on the mobile device at step 410. User entry of query terms is detected at step 420. At step 430, entered characters are sent to the server by the instructions. The characters are matched to a number of relevant categories or groups of results at step 450, the categories being predetermined from previous search results. For example, if a word has a number of different meanings, then the results may include several discernable groups. A query term such as “queen” might produce results relating to a well known rock music band of that name, or the royal family, or a queen bee for example. At step 460 the most relevant of the categories is downloaded, offering a choice of categories of results. This is displayed at step 470, by a background process, optionally in the same screenview as the query entry window.

Further query terms can be detected at step 480, which can lead back to step 430. Or user selection of category can be detected at step 500, which can lead to the query server being alerted to restrict the search results accordingly. Or completion of the query may be detected at step 510 which can be sent to the query server to get search results at step 490. Even if the categories are not returned in time before the search query is completed by the user, usually indicated by a user choosing a “search” button, it may still be useful to present the categories to the user during the wait time for the search results, to create the impression of a quick response, and enable the user to select a category while waiting. This can then be used to remove unwanted search results from those that have been downloaded, or the search can be repeated by the query server while the user browses the first screenview for example.

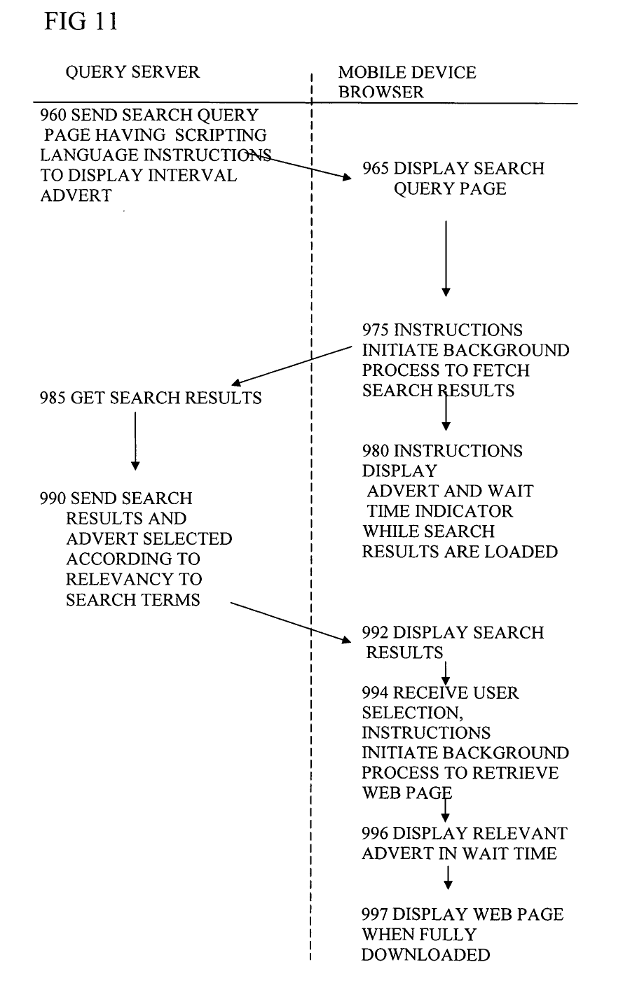

FIG. 11, Embodiment Involving a Presenting Information During Wait Intervals

FIG. 11 shows a sequence of events for an embodiment which uses a background process to display information such as advertising material during the wait interval while a page is being downloaded. This can reduce the amount of page space per result item by not displaying adverts at the same time as result items. Instead, the interval between pressing a key that initiates a page change and the desired page being ready to be displayed, is used to display advertising content. The advert could have a minimum display time if the target page became ready earlier than the user could possibly have had time to read it. The advert could be displayed even if the target page is already available on the device. This scheme will be most friendly to the user if perceived to only be used when there really is a delay anyway, and provided there is some indication of progress of the loading of the target page.

In the example of FIG. 11, at step 960, a search query page is sent with interval advertising material and scripting language instructions for presenting the material. At step 965 the search query page is displayed, and the background process stores the interval advert (or presents it in a small window, or as an audio presentation to avoid interrupting the query entry). At step 975, the instructions are used to initiate a background fetch process, while the advertising material is displayed at step 980, optionally with an indication of a remaining wait time. The server gets search results at step 985 and selects another interval advert, selected to be relevant to the query. These are sent to the browser at step 990. At step 992 the search results are displayed. The user selection of one of the results is received at step 994 and a URL sent to retrieve the original web page. If this is carried out by a background process, then during this interval the relevant advert can be presented by the browser at step 996. Once the web page is downloaded, it can be displayed instead of the advertising material, or the advertising material can be reduced to a small window if the browser and the screen size allows.

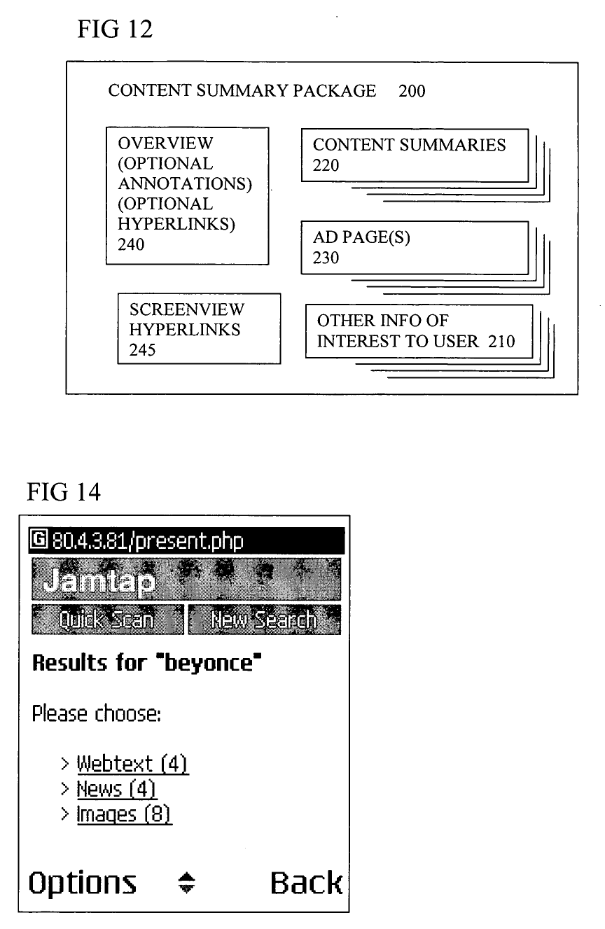

FIGS. 12-16 Search Results: Content Summaries, Overivews and Packages

The embodiments described involve browsing results of a search query by receiving results on a wireless device. Optionally this is in the form of a package which can include a content summary for each item of the search results, including multimedia items and a number of other features to make browsing more rapid or convenient, especially to overcome physical limitations of handheld mobile devices with limited capabilities for display or for scrolling or selecting, and the physical limitations of the wireless network. This will be referred to as a content summary Package CSP. The package can be arranged as a page extending over a number of browsable screenviews.

This can provide more information and/or a more convenient arrangement for browsing, compared to the normal annotated result list provided by traditional search engines. The quantity and presentation of the summary of each content item can be tailored to suit the device to best take advantage of the mobile device physical format. For example each content summary could be arranged to fill a small format screen of a handheld mobile device. The content summarized can be Web pages, news items, sound or video clips or many other types of content for example. By providing a richer summary than existing mobile search engines, a user can find a desired or optimum page more quickly.

Particularly where background processes can be used to enable more rapid browsing of many summaries, the mobile search can be more efficient and less frustrating for the user.

A results page of content can be an instance of an XHTML (or other) document that in some embodiments can be much larger than the physical display of the mobile device, such that the width of the viewable content in this page is the same as the physical display width, but the height is much greater. This is one way of enabling many results to be downloaded and viewed by scrolling without the need to reload a new page each time. In some cases this can be seen as consisting of a vertical stack of adjacent (or, optionally, spaced out with white space) screenviews such that each page region fits the display. There is also the case where the screenview may be somewhat taller than the actual display size, but still much smaller than the full content page, and the content within the bottom portion of the screenview is viewed by scrolling a little within the screenview.

There is also the horizontal stacking case, where the page of content is defined as an instance of an XHTML or other document that was much larger than the physical display of the mobile device, such that the height of the viewable content in the page was the same as the physical display height, but the width was much greater. A page then consists of a horizontal stack of adjacent (or, optionally, spaced out with white space) screenviews such that each screenview substantially fits the display. A page may have a combination of vertically and horizontally stacked screenviews. Another possibility is a stack in the time domain, much like a timed presentation of slides or video frames, and this again can be combined with horizontal or vertical stacks. Any of these can be combined with multimedia types of presentation.

A page is one possible presentation format of a content summary Package, useful to take advantage of widespread use of browser software to read hypertext pages in mark up languages, such as the standard XHTML microbrowser built into many mobile device. If this is the chosen presentation format, then the screenview is the presentation format of an individual Content Summary.

Other presentation formats are possible, using for example a custom Java application client downloaded onto the device. In this case, a content summary Package can be formed within an XML document or even within a binary file format, and individual content summaries could be expressed likewise as (smaller) XML documents or binary files.

Screenviews are intended to encompass a portion of a web page (or other page based display medium) suitable for display by a browser or equivalent software on a mobile device. The size of a screenview can be determined dynamically by discovering the actual size of the display of the device being used, or by taking a default value based on estimates or typical devices used most frequently. A margin can be provided around the screenview to allow for different actual display sizes. The content summary sizes can be chosen to substantially fill a screenview of the mobile device. A next screenview can be selected by a user for display by scrolling, or more conveniently in some embodiments by using a hyperlink. Users can access a start point of the information by clicking on a button or a hypertext link embedded elsewhere in the web page. This is often much more convenient than scrolling, which is too time consuming if there are multiple screenviews to scroll through, or if it is desired to flick backwards and forwards between an overview and content summaries for example.

The package of screenviews can be implemented as a page in XHTML Basic for example. As indicated by the W3C website, XHTML Basic is the second Recommendation in a series of XHTML specifications. The XHTML Basic document type includes the minimal set of modules required to be an XHTML Host Language document type, and in addition it includes images, forms, basic tables, and object support. It is designed for Web clients that do not support the full set of XHTML features; for example, Web clients such as mobile phones, PDAs, pagers, and settop boxes. The document type is rich enough for content authoring. XHTML Basic is designed as a common base that may be extended by additional modules from XHTML Modularization such as the Scripting Module. Thus it provides a common language supported by various kinds of user agents such as browsers. It is useful if the page format can be read and presented by many different versions of “legacy” browsers to maximize the user base among existing mobile telephone users for example.

An overview of search engine activities can be summarized as follows:
Spider the Web as conventional search engines do.
Extract content summaries from each web page based on a category of content found on that page (e.g. text, image, video)
Store and index summaries in an indexed database.
Receive a query, obtain search results from the indexed database.
Customize the display of the content summaries to the mobile device and/or its browser,
Send a set of summaries to user as a package for a browser to present, optionally include advertising material and other information of potential interest, together with code for background processes.
Display using browser on the mobile device, starting with a short overview of items in the results, optionally including an entry to the advertising material, using background processes to reduce delays.
Subsequently display each larger summary in response to input such as clicking on a URL, on a button, or scrolling by the user.

This can help overcome problems such as mobile devices having small screen sizes, and X-HTML being limited in capability. It need not be limited to particular mobile device characteristics or browser. It helps overcome the problem that network fetches are time-expensive, and that even newer faster networks will suffer from congestion at peak times and show latency effects.

The generation of these content summaries can be carried out offline or on demand, or some combination of these options. If done offline, they can be stored in an indexed database which is integrated within an overall search engine architecture, so that the summaries may be more rapidly retrieved in response to a user query. If the summaries are generated on demand, this requires following the links in search results obtained from existing search engines, to obtain the whole content items, such as web pages. The system can optionally be set up as a metacrawler acting as a front end to existing search engines. The summaries can then be created from the whole content items obtained from multiple search engines.

Embodiments can provide a minimum system which streamlines the process of mobile search. It can be implemented as a metacrawler in front of existing search engines (e.g. Google™, Yahoo™, MSN™) or as a subsystem which is more tightly integrated into an overall search engine system. An additional level of summarisation of the original content items (whether they be Web pages, WAP pages, news items, sound or video clips, or local information such as e.g. yellow pages or white pages) can be created in addition to the normal annotated results list provided by search engines like Google. It transmits these content item Summaries to the mobile device as a single-shot package (a CSP) in response to a keyword-initiated search.

The additional level of content summaries gives the user sufficient information about the content he/she is seeking that he can have high confidence in it before clicking through to the underlying content item on the WWW. The system allows the mobile user to quickly navigate through a set of content summaries cached within the local device browser to find what they are looking for, without the need to incur expensive clicks over the mobile network. In this way the user experience of mobile search is dramatically improved.

CSPs can be implemented as XHTML Mobile Profile or XHTML Basic web pages, using either bookmarks or multipart messages, allowing the result set to be arranged as a stack of linked screenviews.

Content Summary Packages

The search result set, plus the additional set of larger summaries of these same items, called Content Summaries, is received by the user in a single query and response operation over the wireless network, so that the user may more easily identify the item he or she is seeking before having to initiate subsequent query and response operations over the network.

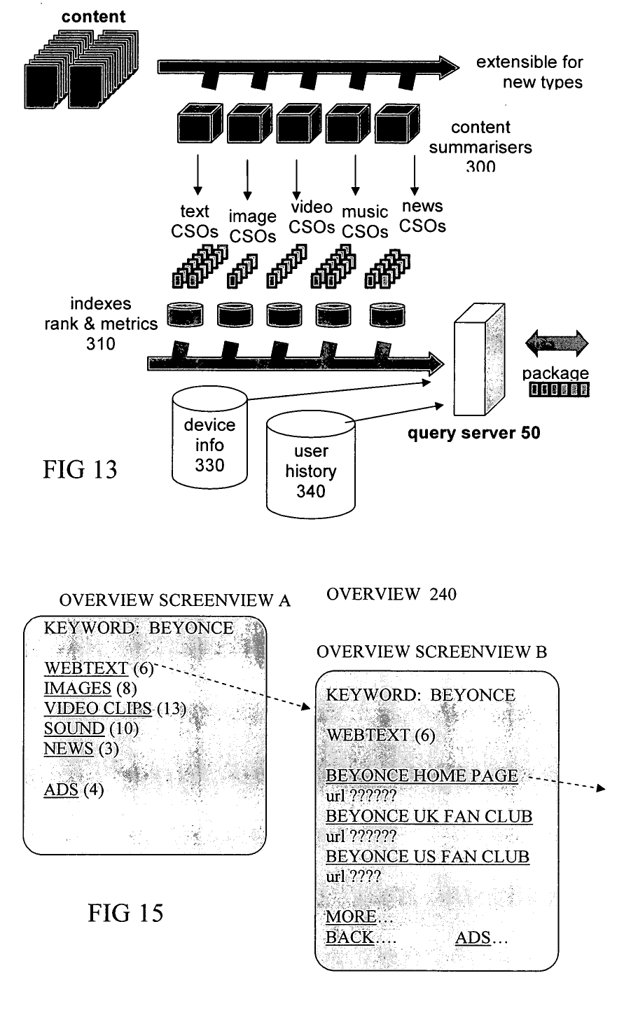

The package of overview of search results and the Content Summaries to be displayed to the user on the wireless device can be in a format suitable for the native browser on the device, or can use or include a separate software program running as a user application on the device. FIG. 13 shows schematically an example of a content summary package. It has an overview 240, content summaries 220, screenview hyperlinks 245, advertising screenviews 230, and other materials 210. The overview can have optional annotations, can be formed of several screenviews showing different overviews, and optionally it can have hyperlinks to other screenviews. In some cases, the overview can be displayed in a separate frame so that it can still be viewed when viewing other screenviews.

FIG. 14 shows an example of an arrangement for creating the content summaries.

Content is fed to content summarisers 300 for summarizing a different category or type of content. So one content summariser produces text content summaries, another produces image content summaries, another produces video content summaries, another produces music content summaries, another produces news content summaries. These content summaries are stored as content summary objects (CSOs) and stored in databases which are indexed. The indexes 310 are consulted when the query server 50 searches for relevant content summaries. The content summaries found are fed to the query server for incorporating into a package. A store 330 of device information and a store 340 of user history 340 are provided to enable the query server to tailor the package. The query server can create the overview screenviews from the content summaries.

The content summary database or index to it can store meta-data about its respective content item or the web page holding that item as follows. Such meta data might constitute one, some or all of the following aspects of a media item:

size

image/frame dimensions

length in time

CRC (cyclic redundancy check) over part or all of data

Embedded meta data, eg: header fields of images, videos etc

Media type, or MIME-type

The overview can be a conventional annotated list having brief descriptive information of up to 60 or so words on each item, plus other descriptive information such as the source web site, date, etc, or can be provided in other forms such as a non-annotated list, a list of groups of items, a multilevel list, capable of showing more or less information about each item or groups of items, or an array of thumbnail images, or a scrolling sequence of views of successive items, for example.

Content Summaries

A content summary can encompass an aspect of a web page (from the world wide web or intranet or other online database of information for example) that can be distilled/extracted/resolved out of that web page as a discrete unit of useful information.

It is called a summary because it is a truncated, abbreviated version of the original that is understandable to a user.

Example types of content summary include (but are not restricted to) the following:
Web page text—where the content summary would be a contiguous stretch of the important, information-bearing text from a web page, with all graphics and navigation elements removed.
News stories, including web pages and news feeds such as RSS—where the content summary would be a text abstract from the original news item, plus a title, date and news source.
Images—where the content summary would be a small thumbnail representation of the original image, plus metadata such as the file name, creation date and web site where the image was found.
Ringtones—where the content summary would be a starting fragment of the ringtone audio file, plus metadata such as the name of the ringtone, format type, price, creation date and vendor site where the ringtone was found.
Video Clips—where the content summary would be a small collection (e.g. 4) of static images extracted from the video file, arranged as an animated sequence, plus metadata

The collection of summaries is obtained by scanning the WWW and is then indexed and made available to the search service. The items scanned can include items from the deep web, that is dynamically generated web pages generated from live databases behind the web page, such as weather forecasts, travel timetables, stock quotes and so on. Search queries result in a collection of relevant content summaries being returned to the user.

A notable advantage of obtaining, storing and sending results in content summary units rather than page units is that they can be adapted to different screen sizes more easily to make better use of the confines of the limited screen real-estate of a typical hand held mobile device. Further, the presentation of content summaries such as size, font size, colors or media types used for example, can be tailored depending on the characteristics (browser, screen colour depth and size, video capability, ringtone capability etc) of the user's device. The package size can also be tailored to suit the browser of the device, or characteristics of the wireless channel, such as bandwidth, latency or quality. For example an operator of the wireless network might have a network management system with live information about the currently available bandwidth or other channel characteristics for each connection. This could be passed to the query server, to enable it to dynamically decide how large the next package on that connection can be, and so decide how many content summaries or how large each summary can be without the user noticing undue delay. Furthermore, the size of a screenview can be adapted, to suit an actual display size or other factor for example. This might affect where hyperlinks are located in the page, if it is desired to present hyperlinks at the same place in each screenview, for ease of use.

This tailoring might be achieved by storing the content summaries in a device neutral representation (which could be XML but doesn't have to be) and then transforming them (possibly with XSLT) either on the fly (per request depending on the user's device) or preparing transformed content summaries in advance.

A second advantage to content summaries is that several can be collated together to form a web page having a number of screenviews, in other words a single CSP that can be transmitted more efficiently to a wireless device. This means that several results can be downloaded to a device whilst only incurring one instance of the network latency.

The user can quickly scroll, or page, through the result set. This is in contrast to traditional search results that require the user to click on each search result and wait for it to download before being able to glean any information or determine that the result was not relevant. These features can be combined with using a formatting template as described above which can be reused, to provide further options for altering the screenview by swapping new data into the page.

Content summaries can be grouped into categories, e.g. images, webtext, ringtones, videoclips, news items, addresses. Such categories can be based on content categories or on media type. Categories can be used to assist in the presentation of sets of results to a search query. The user could be offered the choice of category of result before being presented with the results of a particular category. Alternatively, the user could have already expressed a preference (either via their mobile device, or using a desktop to access their mobile-search account preferences), and results from the user's preferred category presented first.

Content summaries can be extracted from web pages containing any machine readable content format. This includes all flavours of HTML, JavaScript, FLASH, PDF, Microsoft Office documents etc. Content summaries might be the whole page if the page is small and has a high information density, or it might just be a small subset of the content of the page.

Content summaries might be inserted by other means than by automated scanning (crawling) of the web. E.g. by manual insertion or custom conversion of third party databases. Content summaries are primarily a way of storing units of information that can be collated and displayed conveniently on a mobile device. A good application of these is in the implementation of a web search service for mobile devices where a lack of alternative means of finding and displaying the information exists. A second application is in access of an online store or marketplace (e.g. Ebay™) where a mobile user wishes to search for a multitude of candidate items to bid on or purchase.

CSPs

Result sets from searches initiated by a mobile user can be arranged as a stack of linked content summaries, each result corresponding to a single content item. These Summaries are then combined into a single package (CSP) prior to transmission to the mobile device.

This CSP can be formatted as a web page, and can include scripting language instructions for one or more purposes as discussed above. Individual content summaries can be linked within Summary Packages using intra-page hyperlinks (called bookmarks in HTML, XHTML Basic and XHTML Mobile Profile). Clicking on a bookmarked link is then just a jump in the view of the current page and does not involve the browser returning to the network to fetch the next page. The user receives this Summary Package (actually a stack of web screenviews) in a single network fetch-response cycle and can then browse through the contained results with quick clicks on the intra-page links.

In XHTML Mobile Profile the anchor tag <a> with the href attribute set to a bookmark can be used to implement this method. The effect of this navigation method is to enable page-by-page scrolling rather than the pixel-by-pixel or line-by-line scrolling normally offered via the device's up/down/left/right navigation keys.

Bookmarks are a standard and well understood technique in desktop web pages. They are normally used to offer fast links to specific sections of a large documents. However, bookmarks have not often been used to link consecutive screenfuls of content—this being especially useful on a mobile device which typically has a reduced keyboard with no page up or page down key, as well as a small format display.

Content Summaries are a very convenient unit for each screenview in a linked stack of search results. Each screenview is then a candidate result item for the search query, and the set of results can be stepped through with a quick-to-load (because it's just a move) click per result. This clicking can step through results of different types (for example different media categories such as text or images) simply by arranging for the stack of content summaries (screenviews) to come from these different categories.

CSPs can incorporate sponsored links similar to those used in the desktop search service environment. Where the advertiser has mobile-specific webpages, these sponsored links can point directly at these pages. However, where an advertiser does not have mobile-specific web pages, they can instead provide advertising collateral to the search service.

For each content summary item, a hyperlink having a URL can be provided to let the user click down to the underlying content item found on the WWW. Each and every page in this system can have a single AdLink. When a user clicks on an AdLink, an AdPage is presented, which is a textual page which is carried in the payload of the search query response page. A link at the bottom of the AdPage is provided to make a request over the wireless network to load further advertising material.

### OVERVIEW EXAMPLES

An example of an overview page is shown in FIG. 14, another example, showing two levels, is shown in FIG. 15. In FIG. 14, an overview includes fields for offering a quick scan or a new search. A next line shows the keyword or words, then the categories of webtext, news, and images together with a number in brackets of items found. The example shows a search for the well known singer “Beyonce”™ for example. In FIG. 15, a multi screenview overview is shown, together with hyperlinks to select them.

Screenview A shows a top level showing the number of items found in different categories. Each underlined text is a hyperlink to another screenview. For example the clickable link “Webtext” leads to screenview B. This shows an annotated list of some of the items. For each item, the underlined text will link to the content summary for that item, and a URL is shown to enable a user to download the whole content item.

Another option is the following layout:

Results for “beyonce”™

Please choose:
Web (4)
Wap (4)
News (12)
Local (3)
More (54)

Plus a single clickable AdLink at the bottom

When a user clicks on any of Web, Wap, News, or Local hyperlinks they are taken to a sequential list of content items Summaries within that category.

When a user clicks on Other, they are taken to a second Results List, structured as follows, which contains the heavier multimedia summaries:

Results for “beyonce”™

Please choose:
Images (14)
Ringtones (15)
Videos (15)
Back

When a user clicks in either of these category headings, there can be a fetch over the wireless network to display the summaries of those items, rather than including them in the first sent package, if there is not sufficient space in the first sent package. Sets of image summaries, ringtone summaries and video summaries may each take up about 20 Kbytes of memory, chosen according to user convenience or other factors, as described below in more detail.

In a 3G version of the system, the Summaries for these heavier multimedia items are pre-fetched with the rest of the Summaries in a single shot operation, although still spread out onto two pages for ease of presentation. It should be understood that many different arrangements for the content or layout of these overview screenviews, are possible, these examples are illustrative only.

Content Summary Examples

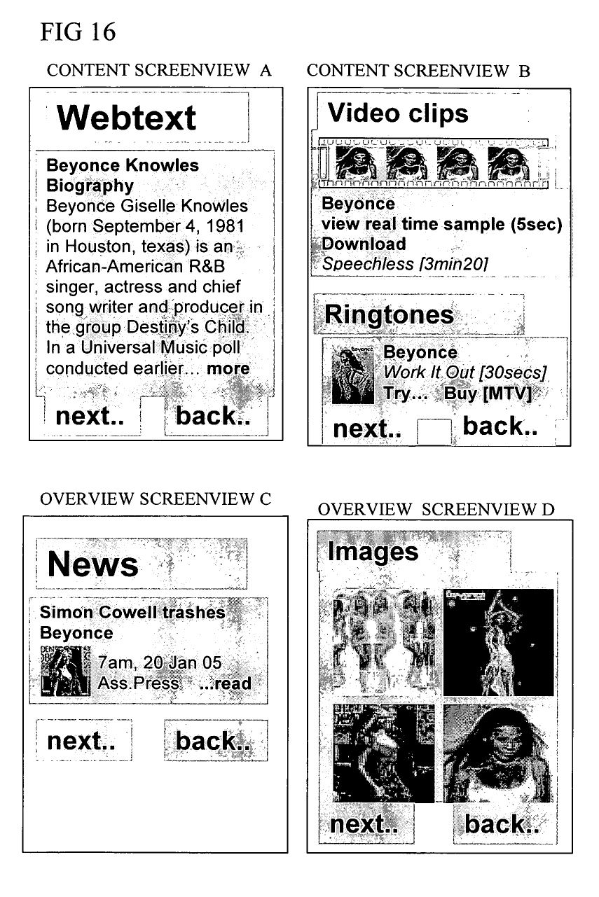

FIG. 16 shows several examples of content screenviews which could be found for the example keyword “Beyonce”™, as described above and shown in the overview screenview examples of FIGS. 14 and 15, from web pages available online, as an example of a typical multimedia web site. Each screenview has one content summary, though in principle there can be more than one per screenview. Each screenview may substantially fill the screen, or there may be room on screen to show other items such as a navigation bar to show how far through the package is the current view. Or a part of the overview screenview could be shown. Each content screenview in this example has hypertext links at the bottom, to a next screenview or back to a previous screenview. Screenview

A shows an extract of a webtext item. Screenview C has an overview in the form of a news headline and thumbnail picture. Screenview B shows a content summary for a video in the form of a storyboard of video frames and an example for ringtones or other audio. For the video clip, the frames shown can be presented as a timed sequence of frames changing every few seconds for example. A hyperlink is provided to download a larger summary in the form of a real time sample of the video, lasting 5 seconds in this case. Another hyperlink provided to download the entire video clip, several minutes long in this case. For the ringtones, a hyperlink labelled “try” is provided to the ring tone to be listened to. Another hyperlink enables the ringtone to be bought. Screenview D shows an example of an overview for images showing a number of thumbnail images.

Each can be provided with a hyperlink to download a larger, higher resolution image. Although shown with one content summary per screenview, the content summary can of course extend over two or more screenviews, and the hyperlinks can be located on each screen view, or on each content summary for example.

For some types of content, it may be convenient to provide the user with an additional level of content summary before sending the request to download the actual content item. This “larger” summary could be larger than the standard content summary, but still significantly smaller and therefore faster to download than the original content item on the world wide web. It could involve filling an entire package with just one larger summary. Two examples of where this would be useful are provided below.

### EXAMPLE 1

### Searching for Content in Web Pages

When searching for information in web pages, it may be useful to provide the user the option of a larger summary that was built up from sections of text extracted from multiple web pages from the source web site, where these sections were still inter-linked using a similar hypertext navigation structure to that of the original web site.

These sections would be arranged for presentation as screenviews within a larger page, for rapid viewing with clickable hyperlinks, without the need for further query and response operations across the wireless network.

### EXAMPLE 2

### Searching for Content in Video Clips

When searching for video clips, this larger summary would simply be a longer portion of the video clip than was displayed in the first-level content summary of that clip. If the user wasn't sure from the first-level content summary that the video clip was the one that he or she was seeking, they could download the larger summary before deciding to incur the significant time that it would take to download the full video clip.

Size of Content Summary Package

Depending on the mobile network, there is an optimum size of the CSP which balances the benefits of providing more summaries with the additional cost and time incurred from transmitting a CSP compared to a smaller web page: Examples (which can be refined empirically to suit users) now follow. These values may be very different for different networks or different conditions, different user preferences, different applications, and may be varied dynamically according to network conditions for example.

a) Web Page Text Summaries: Up to 1 Kbyte of body text from the centre viewing area of the web page, plus title, size, date, content attribution, search engine attribution. The keyword must be contained within this body text. 6 summaries, total 6 Kbytes, plus 1.2 KByte for AdLinks+AdPages (assuming about 20 or 25 words per ad)

b) WAP Summaries: The entire WAP page, truncated to 0.4 Kbytes. 6 summaries, total 2.4 Kbytes, plus 1.2 KByte for AdLinks+AdPages

c) News Summaries: Up to 1 Kbytes of body text from the news item that contains the keyword, plus title, size, date, content attribution, search engine attribution. The keyword must be contained within this body text. 6 summaries in the sequential set, total 6 Kbytes, plus 1.2 Kbyte for AdLinks+AdPages

d) Local Summaries: The entire Local results page, plus date, content attribution (e.g. Yellow Pages) plus search engine attribution (e.g. Google Local), truncated to 0.4 Kbytes. Up to 6 summaries in the sequential set, total 2.4 Kbytes, plus 1.2 Kbytes for AdLinks+AdPages

Total payload for Summaries in a) to d)=21.6 Kbytes

e) Image Summaries: 4 image thumbnails per screen, 1 AdLink per screen, 4 screens, 16 images in total, 1 Kbyte per image. When you click in image you get a single image thumbnail plus metadata, plus a URL link through to the underlying source document on the Web. Metadata contains title of image, source web site, search engine attribution, date. 16 Kbytes per set, plus 0.8 Kbytes for AdLinks+AdPages

f) Ringtone Summaries: Sets of ringtone previews, plus vendor name, plus price if available. Up to 16 Kbytes per set plus up to 1.2 Kbytes for AdLinks+AdPages

f) Video Summaries: 2 thumbnails per screen, 1 AdLink per screen, 2 screens, 8 video summaries in total. Each thumbnail sits within a perforated black frame containing an animated GIF with 4 frames. When you click on the thumbnail you get a single thumbnail plus metadata including title of image, source web site, search engine attribution, date. Up to 16 Kbytes per set, plus 0.4 Kbytes for AdLinks+AdPages
Mobile device: The wireless device may be a mobile handset type of device, or any type of mobile computing device, such as a laptop PC with a built-in connection to a wireless network, or with a connection to an external wireless device such as a mobile handset. It may be any mobile communication device adapted to operate within and receive data over a wireless communication network. It may also have voice communication capabilities. It can be any of a data messaging device, a two-way pager, a cellular telephone with data messaging capabilities, a wireless Internet appliance or a data communication device (with or without telephony capabilities), such as a laptop computer or a PDA for example. For use with a cellular network, the device may incorporate a General Packet Radio Service (GPRS) communication subsystem or other equivalent, or may use a voice telephone channel to pass the data in the form of tones for example, following established principles. The mobile device can be made up of several devices, for example it can have a separate display, separate headset or earpiece, separate keyboard, separate storage device, separate power supply and so on, each coupled by wires or wireless connections such as Bluetooth connections. The web browser on the mobile device can be suitable for presenting documents in mark up languages such as HTML and its variants, and should be HTTP compatible. Examples include Netscape Navigator, Sun Hot Java Browser, Microsoft Internet Explorer or micro browser software having similar functions. Many currently available handheld devices with browsers are at least compatible with XHTML Basic and XHTML mobile profile.

The wireless network can be a cellular network such as a GSM or UMTS or CDMA network for example. Other types of mobile devices and wireless networks having similar delays or latencies are also contemplated. In an alternative embodiment, the search is not of the entire web, but of a limited part of the web or a given database. In another alternative embodiment, the query server also acts as a metasearch engine, commissioning other search engines to contribute results (e.g. Google™, Yahoo™, MSN™) and consolidating the results from more than one source.

The Web server can be a PC type computer or other conventional type capable of running any HTTP (Hyper-Text-Transfer-Protocol) compatible server software as is widely available. The Web server has a connection to the Internet 30. These systems can be implemented on a wide variety of hardware and software platforms.

The query server, and servers for indexing, and for crawling or metacrawling can be implemented using standard hardware. The hardware components of any server typically include: a central processing unit (CPU), an Input/Output (I/O) Controller, a system power and clock source; display driver; RAM; ROM; and a hard disk drive. A network interface provides connection to a computer network such as Ethernet, TCP/IP or other popular protocol network interfaces. The functionality may be embodied in software residing in computer-readable media (such as the hard drive, RAM, or ROM).

A typical software hierarchy for the system can include a BIOS (Basic Input Output System) which is a set of low level computer hardware instructions, usually stored in ROM, for communications between an operating system, device driver(s) and hardware.

Device drivers are hardware specific code used to communicate between the operating system and hardware peripherals. Applications are software applications written typically in C/C++, Java, assembler or equivalent which implement the desired functionality, running on top of and thus dependent on the operating system for interaction with other software code and hardware. The operating system loads after BIOS initializes, and controls and runs the hardware. Examples of operating systems include Linux™, Solaris™, Unix™, OSX™ Windows XP™ and equivalents.

1. A query server of a mobile search engine system for searching content items accessible online, the query server being arranged to send search results across a wireless network to a mobile device for presentation to a user by a browser on the mobile device in response to a search query, and being arranged to send at least a first screenview of the search results to the browser, and send instructions in a scripting language to the browser for a background process to be run by the browser at least while the first screenview is presented to the user, the query server and the background process being arranged to cooperate to send further information to the mobile device relating to the search results, for presentation to the user under the control of the scripting language instructions.

2. The query server of claim 1, being arranged to send the first screenview in the form of a page formatting template, and results data suitable for presentation using the page formatting template, and the instructions being arranged to reuse the page formatting template to prepare at least some of the further information for presentation.

3. The query server of claim 2, arranged to send one or more further page formatting templates for different categories of the search results, and further results data of a different category, the instructions being arranged to control the presentation of the further results data by selecting one of the page formatting templates according to the category of the further results data to be presented.

4. The query server of claim 2, the instructions being arranged to alter a page being displayed by the browser by swapping data within the currently used template.

5. The query server of claim 1, the background process being arranged to fetch further information from the server relating to a currently-presented search result without waiting for user input, and canceling the fetch if the user selects a different search result, the further information comprising any one or more of: further search results similar to the currently displayed search result, more details of the currently displayed search result, a longer summary or extract of the currently displayed search result, and other information.

6. The query server of claim 1, the search results having content summaries of original content items and the query server being arranged to cooperate with a content summariser for generating content summaries, a format of the content summaries being arranged according to a category of the corresponding original content.

7. The query server of claim 1, the first screenview of the search results having an overview of groups of the search results.

8. The query server of claim 1, arranged to carry out a preliminary step of sending a search query entry window for display by the browser, the instructions being arranged to send to the query server characters of a search query entered by a user before the query is completed, the query server being arranged to match the characters to predetermined subject categories derived from previous search results, and send the matching subject categories to the browser for presentation to the user ahead of the presentation of search results from the completed query.

9. The query server of claim 1, arranged to send interval information for presentation to the user, controlled by the instructions during intervals while awaiting a response from the server, the instructions being arranged cause the interval information to be stored until a suitable interval is detected then cause the interval information to be presented to the user.

10. The query server of claim 9, the interval information having any one or more of: advertising information, advertising information related to the search being undertaken, news items, information about the search system, estimated wait time remaining, percentage or fractional progress completed, and other information about the search being undertaken.

11. A method of providing a search service for searching content items accessible online, to a user of a mobile device having a browser and being coupled by a wireless network, the method having the steps of receiving a search query from the user, getting search results, sending at least a first screenview of the search results to the browser, sending instructions in a scripting language to the browser for a background process to be run by the browser at least while the first screenview is presented to the user, and cooperating with the background process to send further information to the mobile device relating to the search results, for presentation to the user of the mobile device under the control of the scripting language instructions.

12. A method of using a search service for searching content items accessible online using a mobile device having a browser and being coupled by a wireless network, the method having the steps of sending a search query to the search service, receiving from the search service at least a first screenview of search results for presentation by the browser, receiving from the search service instructions in a scripting language for a background process to be run by the browser at least while the first screenview is presented to the user, receiving from the search service further information relating to the search results, fetched by the background process run by the browser, and causing the further information to be presented by the mobile device under control of the scripting language instructions.

13. A query server of a search engine system for searching content items accessible online, the query server being arranged to send at least a first screenview of search results and send instructions in a scripting language across a wireless network to a browser on a mobile device in response to a search query, the first screenview being sent in the form of a page formatting template, and results data suitable for presentation using the page formatting template, and the instructions being arranged to reuse the page formatting template to prepare further screenviews for presentation by the browser.

14. A query server of a search engine system for searching content items accessible online, the query server being arranged to send at least a first screenview of search results and send instructions in a scripting language across a wireless network to a browser on a mobile device in response to a search query, the query server also being arranged to carry out a preliminary step of sending a search query entry window for display by the browser, the instructions being arranged to send to the query server characters of a search query entered by a user before the query is completed, the query server being arranged to match the characters to predetermined subject categories derived from previous search results, and send the matching subject categories to the browser for presentation to the user ahead of the presentation of search results from the completed query.

15. The query server of claim 14, the instructions being arranged to present the matching subject categories with the search query entry window.

16. A query server of a search engine system for searching content items accessible online by users of mobile devices coupled across a wireless network, arranged to send instructions to a browser on the mobile device for a background process to be run by the browser, and arranged to send interval information for presentation to the user controlled by the instructions during intervals while awaiting a response from the query server, the instructions being arranged to cause the interval information to be stored until a suitable interval is detected, then cause the interval information to be presented to the user.

17. The query server of claim 16, the interval information having any one or more of: advertising information, advertising information related to the search being undertaken, news items, information about the search system, estimated wait time remaining, and other information about the search being undertaken,
